(19) United States
(12) Patent Application Publication
(10) Pub. No.: US 2013/0170786 A1
(43) Pub. Date: Jul. 4, 2013

(54) REMOTE WATER SENSING SYSTEM WITH OPTICAL FIBER

(71) Applicant: Chunghwa Telecom Co., Ltd., Yangmei City (TW)

(72) Inventors: Chih-Yih WANG, Yangmei City (TW); Zi-Wen WANG, Yangmei City (TW); Chia-Hsien WU, Yangmei City (TW); Fwu-Yuan TSAI, Yangmei City (TW)

(73) Assignee: Chunghwa Telecom Co., Ltd., Yangmei City (TW)

(21) Appl. No.: 13/683,314

(22) Filed: Nov. 21, 2012

(30) Foreign Application Priority Data
Dec. 29, 2011 (TW) 100149403

(51) Int. Cl. G02B 6/00

(52) U.S. Cl. CPC G02B 6/00
USPC 385/12

(57) ABSTRACT

A remote water sensing system and method with optical fiber, comprises a water sensor which is an optical element designed in accordance with the principle of optical path return loss and provided with reusable features to measure the state of having water or not. A monitoring equipment is provided which is an Optical Time Domain Reflectometer (OTDR), an Optical Frequency Modulated Continuous Wave (OFMCW), or a light source power meter, and used to emit monitoring light signals and accept optical signals returned from the water sensor. A signal processing control unit analyzes the optical signal returned from the water sensor to determine whether the monitoring position is touching the water or not. The method can be used in other fields, such as optical closure watering monitoring, telecommunications facilities flooding alarm, and monitoring and alarm for a low-lying area or river water level of a bridge.

### BACKGROUND OF THE INVENTION

1. Field of the Invention

The present invention is related to a remote water sensing system and method with optical fiber. The contacting medium refractive index changes when a water sensor touches the water, which interferes with the optical path return. The optical path return loss event can then be observed. Moreover, an Optical Time Domain Reflectometer (OTDR), an Optical Frequency Modulated Continuous Wave (OFMCW), or a light source power meter is used to monitor whether a monitoring position touches the water or not.

2. Description of the Prior Art

A conventional optical closure sensor is used to detect the expansion of a non-woven polymer material of the water sensor when watering, which induces optical fiber bending loss and then measures optical path insertion loss. The measuring time is too long and at most detects two event points. Once the non-woven polymer material absorbs water and becomes saturated, the non-woven polymer material cannot be used again. Furthermore, it is unable to know whether the back end having water inlets before the front end water inlets being repaired. The conventional sensor is not sufficiently economical and efficient.

The present invention provides a remote water sensing system and method with optical fiber which is an innovative improvement over the prior art.

### SUMMARY OF THE INVENTION

The optical cables of telecommunications companies are spread nationwide. In recent years, there have been many natural disasters, such as floods and landslides. Once the telecommunications facilities of the optical fiber networks (such as the optical closures and its contents, i.e., telecommunications equipments and optical closures) come into contact with the water, the telecommunications companies will suffer huge losses. The present invention can provide superior protection for the optical fiber networks of the telecommunications companies. The purpose of the present invention is to provide a remote water sensing system and method with optical fiber, in which the remote water sensing system and method with optical fiber is able to become a perceptional neural network with a reusable optical fiber water sensor, and can be used in many other fields, such as optical closure water monitoring, telecommunications facilities flooding alarm, and/or monitoring and alarm for a low-lying area or river water level of a bridge.

The present invention uses the “return loss event” of the optical path as the monitoring principle. The water sensor is reusable and able to detect more than twenty water-touching events at the same time. Even when the front end water inlets are not repaired, the back end water inlets can be found. Meanwhile, the monitoring method is able to immediately detect the water-touching event points of the monitoring points. When the water sensor touches the water, the water refractive index is about 1.33. The total reflection conditions are not able to be satisfied. Therefore, most of the transmitted light is dispersed and not able to be reflected along the same path. If the Optical Time Domain Reflectometer (OTDR) and the Optical Frequency Modulated Continuous Wave (OFMCW) are used to detect the water sensor location of the optical cable path, the original strong reflection event disappears. If the power value of the reflected light is lower by using the light source power meter, this means that the water sensor touches the water. As a result, one can know immediately whether or not the monitoring position touches the water through the reflection differences that exist from before the Optical Time Domain Reflectometer (OTDR) touches the water to after the Optical Time Domain Reflectometer touches the water. In addition to detecting a water sensor reflection event through the detecting ability of the optical path return loss event of the Optical Frequency Modulated Continuous Wave (OFMCW), the present invention can also achieve water-touch monitoring of the monitoring point. The light source power meter can be used to test the changes of the power value of the reflected light to determine whether or not the monitoring position touches the water.

The present invention is a remote water sensing system with optical fiber which comprises a monitoring equipment which emits a monitoring light signal and accepts an optical signal returned from a water sensor, a water sensor which is a reusable optical element and used to detect the optical path return loss principle to sense whether or not there is water, an optical channel selector which selects a corresponding monitoring optical router and then sends the corresponding monitoring optical path into a plurality of monitoring optical paths and which is analyzed by a signal processing control unit, and a signal processing control unit which analyzes the optical signal returned from the water sensor to determine whether or not a monitoring position touches the water.

In the remote water sensing system with optical fiber mentioned above, the monitoring equipment is an Optical Time Domain Reflectometer (OTDR), an Optical Frequency Modulated Continuous Wave (OFMCW), or a light source power meter.

The water sensor reflects the monitoring light signal to a partial endpoint. When touching the water, the monitoring light diverges so that the monitoring light signal cannot be returned to the partial endpoint.

The optical channel selector imports different monitoring bands in accordance with the different procedures, and then connects to the optical path and the equipment in accordance with the different procedures through the signal processing control unit. The optical channel selector switches the different paths to enlarge the testing optical route number and range, to promote the usage efficiency of the monitoring equipment.

The signal processing control unit is used to monitor the entire procedure and to obtain and analyze the signal to acquire the latest state about whether or not the monitoring position touches the water.

The remote water sensing system with optical fiber of the present invention mainly comprises:

a. deposing a remote water sensing system with optical fiber and deposing a water sensor on each of the monitoring points of the monitoring optical router, the system comprising a plurality of monitoring equipments which emit monitoring light signals and accept optical signals returned from the water sensor, a plurality of water sensors, wherein the water sensors are the optical elements being used repeatedly to detect the optical path return loss principle to sense whether or not there is water, a plurality of optical channel selectors, wherein the optical channel selectors select the corresponding monitoring optical paths and then send the corresponding monitoring optical paths into the monitoring optical paths, and are analyzed by a signal processing control unit, and a signal processing control unit which analyzes the optical signal returned from the water sensor to determine whether or not the monitoring position touch the water;

b. the remote water sensing method with optical fiber, if necessary, controls the optical channel selector switching to the testing optical route, and the monitoring equipment imports the optical signal of the monitoring band into a testing optical fiber, and is then transmitted through the optical fiber to the water sensors of each path;

c. the water sensor may reflect the optical signal of the monitoring band to the central office without touching the water, hence, the optical signal cannot be reflected to the central office when the water sensor touches the water, and the monitor equipment simultaneously accepts and measures the optical signal reflected from the optical router, and further acquires the power value of the reflected light of each water sensors; and

d. analyzing the optical power loss value of each water sensor to measure whether or not the water sensors of the monitoring positions touch the water.

A remote water sensing method with optical fiber is providedas mentioned above, in which the remote water sensing method with optical fiber measures the state of the optical paths of step d, also comprising:

a. measuring the monitoring optical power value of a water sensor and, when the result is smaller than the threshold value, this means that the monitoring position is touching the water;

b. measuring the monitoring optical power value of a water sensor and, when the result is close to the original value, this means that the monitoring point state is normal.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 shows the water sensor monitoring structure and schematic diagram.

FIG. 2 shows a monitoring schematic diagram of the remote water sensing system and method with optical fiber of the present invention.

FIG. 3 shows the OTDR/OFMCW monitoring structure and schematic diagram of the remote water sensing system and method with optical fiber of the present invention.

FIG. 4 shows the light source power meter monitoring structure and schematic diagram of the remote water sensing system and method with optical fiber of present invention.

FIG. 5 shows an actual measurement diagram of the water sensor of the present invention before touching the water.

FIG. 6 shows an actual measurement diagram of the water sensor of the present invention after touching the water.

FIG. 7 shows an actual measurement diagram of the water sensor of the present invention which naturally dries after touching the water.

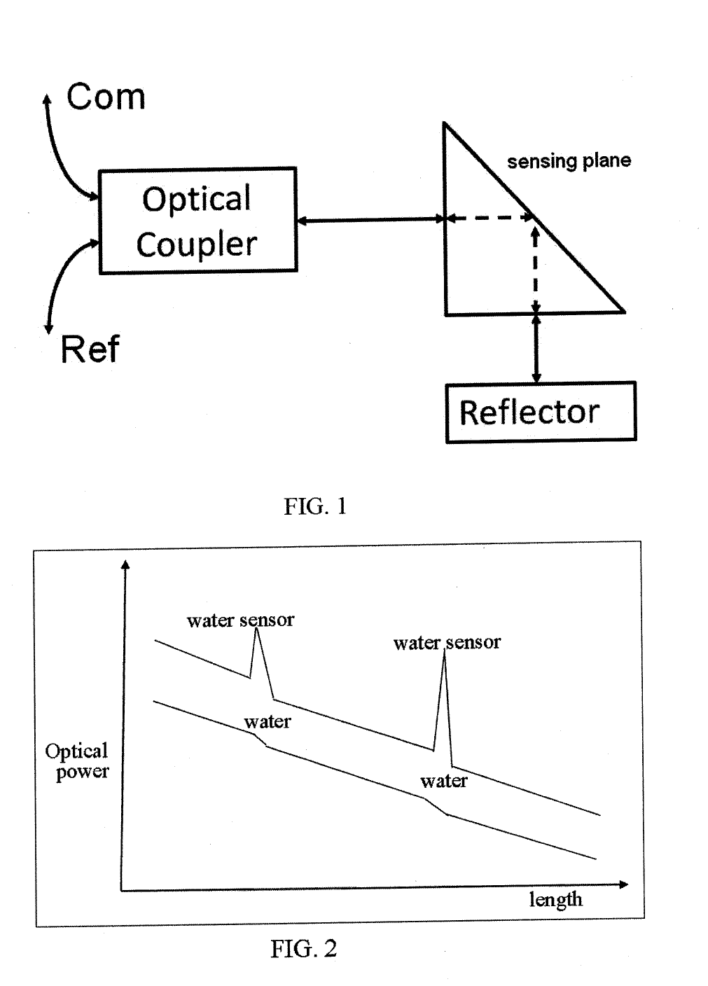

### DETAILED DESCRIPTION OF THE PREFERRED EMBODIMENT

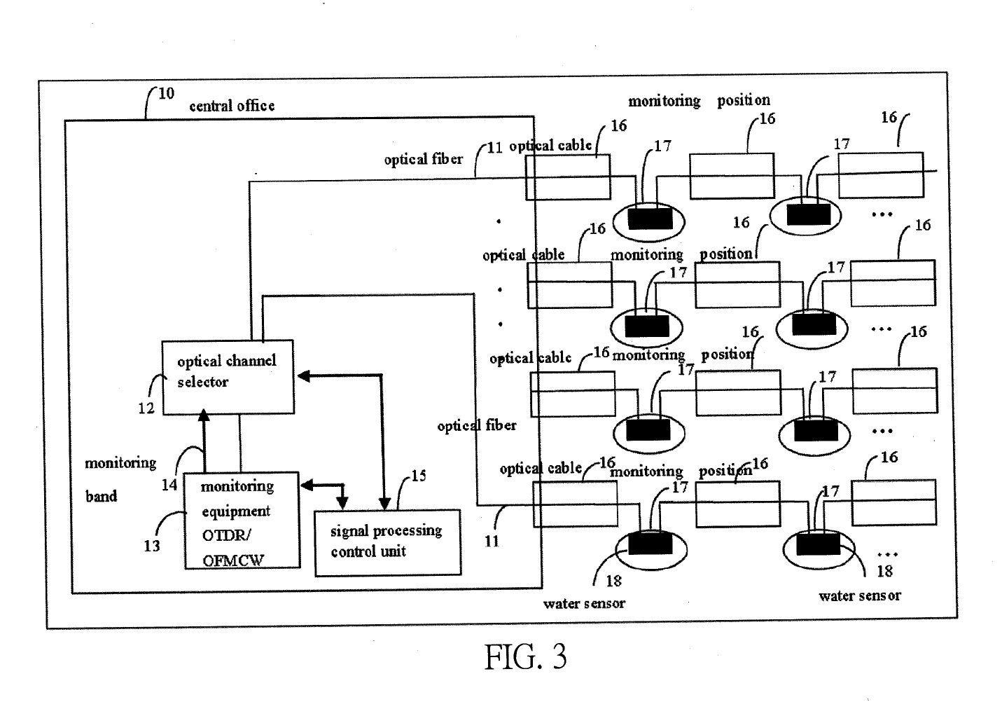

The present invention provides a remote water sensing system and method with optical fiber, which provides a more economical and efficient monitoring method. As shown in FIG. 3, the main monitoring equipment is deposed in a central office 10. The monitoring equipment is an Optical Time Domain Reflectometer (OTDR) or an Optical Frequency Modulated Continuous Wave (OFMCW) 13, which emits an optical signal of a monitoring band 14. The optical signal is transmitted by an optical channel selector 12 to an optical fiber path 11, an optical cable 16 outside the central office 10, a monitoring position 17, and finally a water sensor 18. Alternatively, a light source power meter 13 emits the monitoring light signal to the optical fiber path 11, the optical cable 16 outside the central office 10, the monitoring position 17, and then the water sensor 18. The light signal of the monitoring equipment is also be able to be detected by the light source power meter.

After entering the water 18, the monitoring signal is bifurcated into two lights. One of the lights of 95% optical power is transmitted to the next monitoring position 17. In the meantime, the other light of 5% optical power penetrates the water sensor 18 and returns in the same path, passing through the monitoring position 17, optical cable 16, and optical fiber 11, and then enters into the optical channel selector 12, where it is accepted and measured by the Optical Time Domain Reflectometer (OTDR), the Optical Frequency Modulated Continuous Wave (OFMCW), or the light source power meter. Thus, it acquires the return loss waveform diagram, or the changes of the power value of reflected light of the whole optical path water sensor.

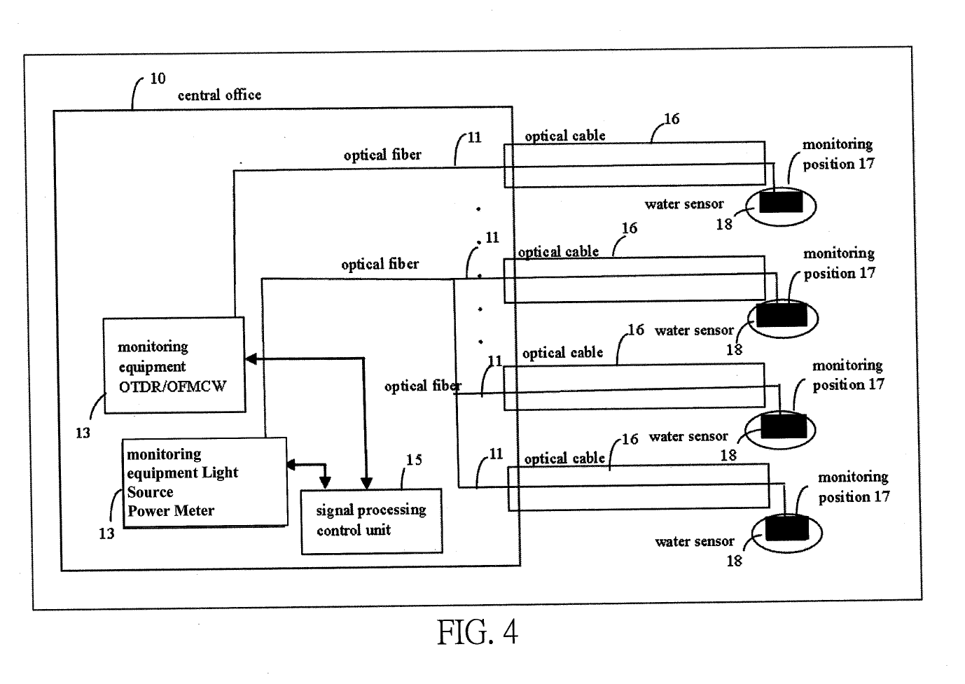

As shown in FIG. 4, a signal processing control unit 15 captures the waveform diagram, which shows the latest return loss state and information of the whole optical path water sensor 18. When the water sensor 18 touches the water, the 5% bifurcated light is not able to return to the Optical Time Domain Refiectometer (OTDR), the Optical Frequency Modulated Continuous Wave (OFMCW) 13, or the light source power meter 13. As a result, the original reflection waveform of the water sensor 18 vanishes.

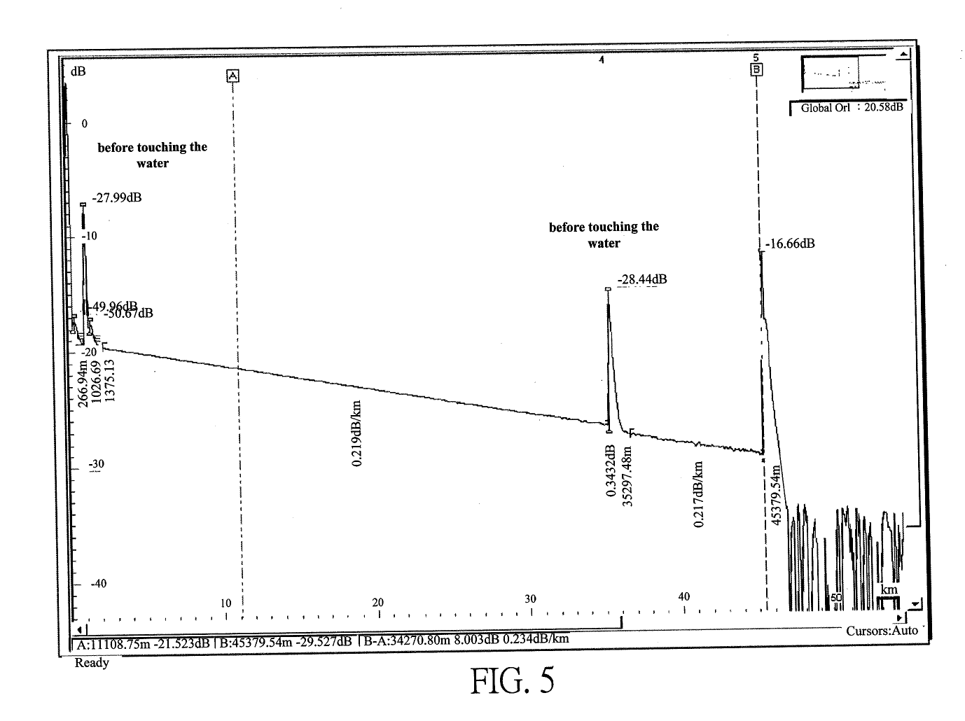

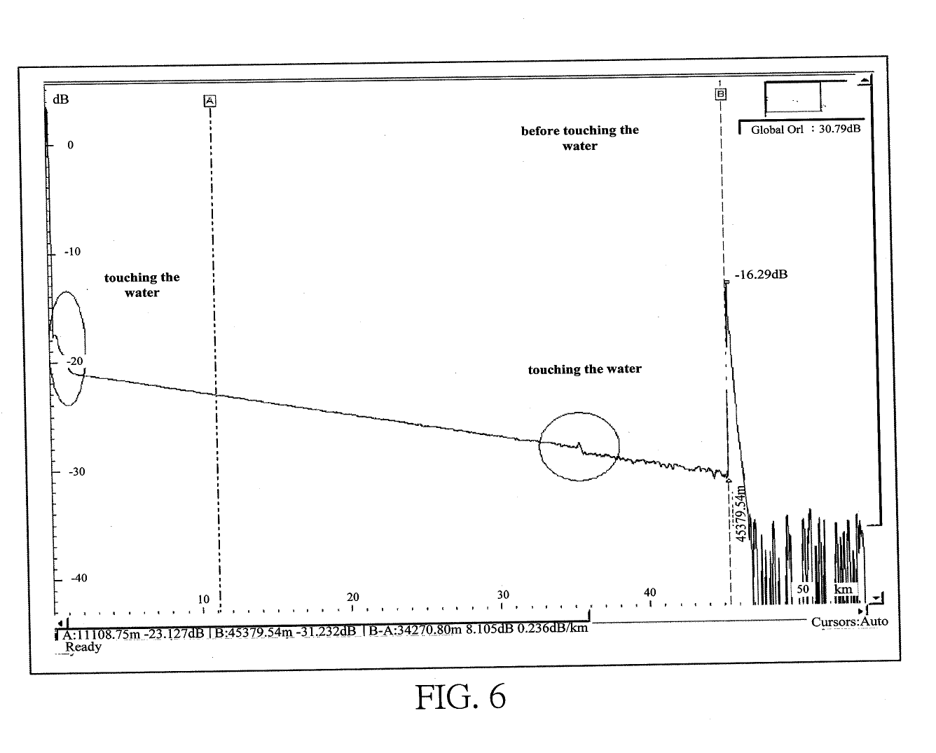

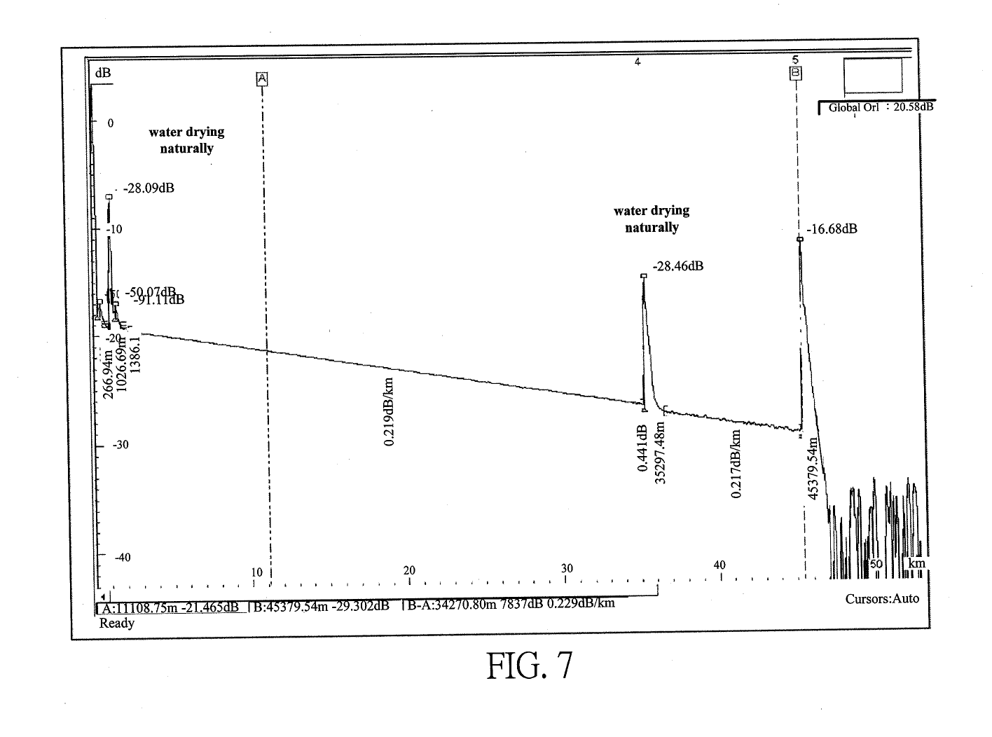

As shown in the actual measurement diagrams FIGS. 5 and 6, through the Optical Time Domain Reflectometer (OTDR), the Optical Frequency Modulated Continuous Wave (OFMCW), or the light source power meter, the signal processing control unit 15 is able to know in which water sensor 18 the water comes in. The signal processing control unit 15 then immediately enters the water-touching measurement flow path. At the time the water sensor 18 dries naturally, the waveform reverts to the waveform diagram of the whole optical water sensor, which is shown in FIG. 7.

The water-touching measurement procedure of the water sensor begins when the Optical Time Domain Reflectometer (OTDR) or the Optical Frequency Modulated Continuous Wave (OFMCW) 13 emits the monitoring band 14, passes through the optical channel selector 12, the optical fiber 11, the optical cable 16, and the monitoring position 17, and finally enters into the water sensor 18. Through the controls by the signal processing control unit to the Optical Time Domain Reflectometer (OTDR) or the Optical Frequency Modulated Continuous Wave (OFMCW), the location of the water sensor water-touch point is measured. This is the alert for the following flow.

The present invention is able to be mixed utilization. This is shown in FIGS. 3 and 4. FIG. 3 shows the usage of the optical channel selector (OCS) 12, which not only imports the different monitoring bands in accordance with different procedures, but also connects subsequently to the optical path and equipment in accordance with the different procedures through the signal processing control unit 15. Thus, the optical channel selector switches the different path to enlarge the number and range of testing optical paths to promote efficient usage of the monitoring equipment.

FIG. 4 shows not using the optical channel selector (OCS) 12, which not only imports the different monitoring light signals in accordance to the different procedures, but also connects subsequently to the optical path and equipment.

The remote water sensing system and method with optical fiber of the present invention possesses these improved features in comparison with the conventional art:

1. The water sensor of the present invention is reusable.

2. The present invention is able to detect more than twenty monitoring point water-touching events.

3. The present invention is able to know whether the back end having water inlets before the water inlets of the front end being repaired.

4. The present invention provides an economical and effective water-touching monitoring program which is able to immediately detect the water-touching state of the monitoring point, so as to prevent losses.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A remote water sensing system with optical fiber, comprising:
a plurality of monitoring equipment, wherein the plurality of equipment emits monitoring light signals and accepts optical signals returned from the water sensor;
a plurality of water sensors, wherein the plurality of water sensors are optical elements being used repeatedly to detect an optical path return loss principle to detect whether there is water;
a plurality of optical channel selectors, wherein the plurality of optical channel selectors select corresponding monitoring optical paths and then send the corresponding monitoring optical paths into the monitoring optical paths, and are analyzed by a signal processing control unit; and
a signal processing control unit, wherein the signal processing control unit analyzes the optical signal returned from the water sensor to determine whether the monitoring position is touching the water.

2. The remote water sensing system with optical fiber of claim 1, wherein the monitoring equipment is an Optical Time Domain Reflectometer (OTDR), an Optical Frequency Modulated Continuous Wave (OFMCW), or a light source power meter.

3. The remote water sensing system with optical fiber of claim 1, wherein the water sensor reflects the monitoring light signal to a partial endpoint and, when touching the water, the monitoring light diverges so that the monitoring light signal cannot be returned to the partial endpoint.

4. The remote water sensing system with optical fiber of claim 1, wherein the optical channel selector imports different monitoring bands in accordance with the different procedures, and then connects to the optical path and the equipment in accordance with the different procedures through the signal processing control unit, and the optical channel selector switches the different paths to enlarge the number and range of the testing optical route to promote efficient usage of the monitoring equipment.

5. The remote water sensing system with optical fiber of claim 1, wherein the signal processing control unit is used to monitor the different procedures and to obtain and analyze the signals to acquire the latest state about whether the monitoring point is touching the water.

6. A method for remote sensing of water with optical fiber, comprising:
using a remote water sensing system with optical fiber of claim 1, and placing a water sensor on each of the monitoring positions of the monitoring optical router;
if necessary, controlling the optical channel selector switching to the testing optical route using the remote water sensing method with optical fiber, the monitoring equipment importing the optical signal of the monitoring band into a testing optical fiber, and then being transmitted through the optical fiber to the water sensors of each path;
using the water sensor which may reflect the optical signal of the monitoring band to the central office without touching the water, wherein the optical signal cannot be reflected to the central office when the water sensor touches the water, the monitoring equipment simultaneously accepting and measuring the optical signal reflected from the optical router, and further acquiring the power value of the reflected light of each water sensor; and
analyzing the optical power loss value of each water sensor to measure whether the water sensors of the monitoring positions are touching the water.

7. The method for remote sensing of water with optical fiber of claim 6, further comprising:
determining whether the monitoring position is touching the water by measuring whether the monitoring optical power value of a water sensor is smaller than the threshold value;
determining whether the monitoring position state is normal by measuring whether the monitoring optical power value of a water sensor is close to the original value.
